(19) United States
(12) Patent Application Publication
(10) Pub. No.: US 2012/0189044 A1
(43) Pub. Date: Jul. 26, 2012

(54) Switching Transistor States to Communicate Faulty Wire in Cable

(76) Inventors: David Soriano Fosas, Terrassa BCN (ES); Carlos Lahoz Buch, Cerdanyola (ES); Laura Portela Mata, Barbera del Valles (ES)

(21) Appl. No.: 13/012,065

(22) Filed: Jan. 24, 2011

(51) Int. Cl. H04B 3/00; H04B 17/00

(52) U.S. Cl. 375/224; 375/257

(57) ABSTRACT

An electronic device has a transmitter, a microprocessor in communication with the transmitter, a receiver that communicates with the transmitter along a cable using differential signaling, and a transistor. The transistor switches states to communicate a signal to the microprocessor when a wire in the cable is faulty.

### BACKGROUND

Many electronic devices include multiple printed circuit boards (PCBs) that communicate with each other through cables. These cables can sometimes become damaged or disconnected and unable to properly transmit data between the PCBs, which can lead to failure of the electronic device.

Diagnosing the cause of data transmission failure between two PCBs can be difficult since the cause of the failure may not be known. For example, such failures can occur from an incorrect assembly on manufacturing, from a faulty cable, transmission unit, or receiver unit.

### BRIEF DESCRIPTION OF THE DRAWINGS

FIG. 1 is an electronic device having a cable connection detection system in accordance with an example embodiment.

FIG. 2 is a cable connection detection system in accordance with an example embodiment.

FIG. 3 is a flow diagram of a method that monitors a cable connection in an electronic device in accordance with an example embodiment.

### DETAILED DESCRIPTION

Example embodiments are apparatus and methods that detect the occurrence of a data transmission failure between two printed circuit boards (PCBs) in an electronic device.

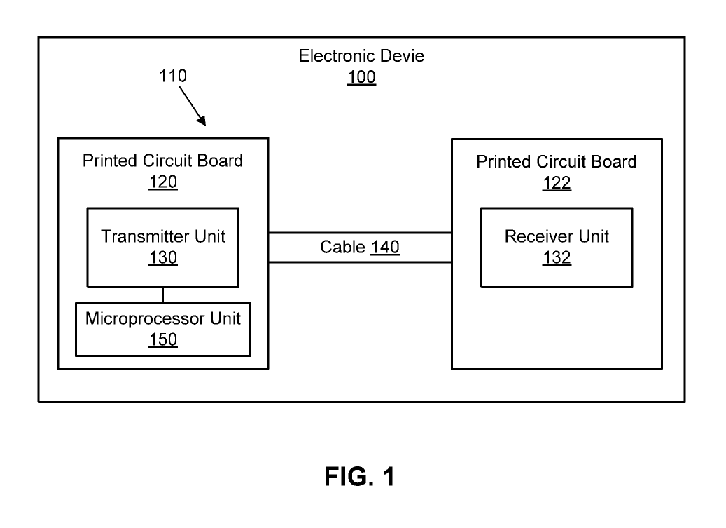

FIG. 1 is an electronic device 100 having two printed circuit boards 120 and 122 and a cable connection detection system 110 in accordance with an example embodiment. The cable connection detection system includes a transmitter unit 130 on PCB 120 and a receiver unit 132 on PCB 122. The transmitter unit 130 and receiver unit 132 communicate with each other through a cable 140. The cable connection detection system also includes a microprocessor unit 150 that communicates with the transmitter 130 on the PCB 120.

The electronic device is not limited to a particular type of device and includes devices having two or more PCBs that communicate with each other. By way of example, such electronic devices include, but are not limited to, printing devices, computers, network communication devices, handheld devices, and other portable and non-portable computers and electronic devices. Further, although two PCBs are shown, the electronic device can include a larger number of PCBs that utilize multiple cable connection detection systems.

In one embodiment, the transmitter unit 130 and the receiver unit 132 exchange data through the cable 140 using differential signaling. A separate or dedicated wire is not required to determine whether a failure in the cable connection occurs between the PCBs. Instead, example embodiments use one or more resistors and transistors to determine whether the cable is electrically connected to the PCBs. When the cable includes two or more wires, example embodiments can determine when a particular signal wire in the cable is broken and/or when the entire cable is disconnected at either of the two PCBs.

One example embodiment uses low-voltage differential signaling (LVDS) in which data is transmitted at high speeds over twisted-pair copper cables that form part of high-speed networks and computer buses. Differential signaling transmits over the cable 140 two different voltages from the transmitter unit 130 to the receiver unit 132 in order to encode data. The transmitter unit 130 injects a small current into one wire of the cable 140, and this current passes through a resistor that matches the impedance characteristics of the cable. The current returns to the transmitter unit 130 along the other wire in the cable 140, and a voltage difference across the resistor determines a logic level (i.e., a logical 1 or 0).

Example embodiments are not limited to LVDS. Other types of differential signaling can also be used, such as emitter-coupled logic (ECL), low-voltage positive emitter-coupled logic (LVPECL), peripheral component interconnect express (PCIexpress), etc.

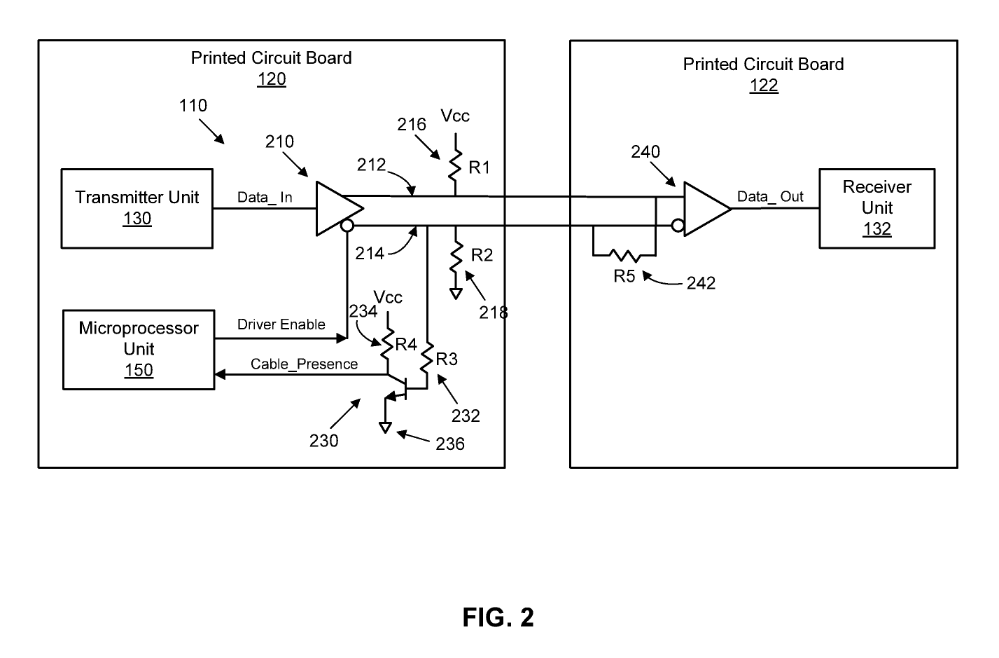

FIG. 2 shows the cable connection detection system 110 in accordance with an example embodiment.

The printed circuit board 120 includes the microprocessor unit 150 that communicates with the transmitter unit 130. A differential driver 210 connects to the transmitter unit 130, the microprocessor unit 150, and cable 140. Data transmits from the transmitter unit 130 to the receiver unit 132 input 130 and is shown as Data_In to the differential driver 210. A driver enable signal transmits from the microprocessor unit 150 to the differential driver 210.

In one example embodiment, the cable 140 includes two or more wires (two wires shown as 212 and 214). One wire 212 connects to the differential driver 210 and resistor 216 (R1) which connects to voltage (Vcc). The other wire 214 connects to the differential driver 210 and resistor 218 (R2) which connects to ground.

The microprocessor 150 connects to the differential driver 210 to provide the driver enable signal and connects to a transistor 230 to detect a cable presence signal. A base-side of the transistor 230 connects to resistor 232 (R3) and wire 214, and a collector-side connects to resistor 234 (R4) and voltage (Vcc). An emitter-side of the transistor 230 connects to ground 236.

A differential receiver 240 in the printed circuit board 122 connects to the receiver unit 132 and wires 212 and 214 of the cable 140. Data received from the transmitter unit 130 transmits to differential receiver 240 and the receiver unit 132 and is shown as Data_Out. A line termination resistor 242 (R5) connects between wire 212 and wire 214. This resistor 242 matches impedances between the wires 212 and 214 of the cable 140 and assists in determining when a mechanical connection of one or more of these wires is faulty or disconnected.

The electronic device can operate in a self-diagnose mode in order to determine the status of the mechanical connection along the cable between the PCBs 120 and 122. In this self-diagnose mode, the differential driver 210 is disabled. When the cable 140 is properly connected between the two PCBs 120 and 122, a small level of current flows through the resistors 216 (R1), 218 (R2), 232 (R3) and the line termination resistor 242 (R5). This current switches the transistor 230 to an on-state and transmits the cable_presence signal as low to the microprocessor 150. When one of the wires 212 and 214 fails or becomes mechanically disconnected, the current stops flowing through the transistor 230 and resistors 216 (R1), 218 (R2), 232 (R3), and 242 (R5). This causes the transistor 230 to switch to an off-state and transmit the cable_presence signal as high to the microprocessor 150. Thus, when the current flowing the through the transistor 230 and resistors 216 (R1), 218 (R2), 232 (R3), and 242 (R5) ceases or interrupts, this condition indicates the mechanical connection of the wires 212 and/or 214 is faulty or disconnected. The cable_presence signal from the transistor 230 to the microprocessor switches logical states (for example, the signal switches from a logical 0 to a logical 1). The microprocessor unit 150 controls and reads the signal from the transistor 236 to determine and diagnose a failure in the cable 140 between the transmitter unit 130 and the receiver unit 132.

The cable connection detection system 110 can utilize various types of electronic resistors, transistors, drivers, and other components. By way of example, the impedances through resistor 242 (R5) have a value of about 80-120 ohm. Furthermore, values of the resistors can be large enough so as not to interfere with high frequency signals (for example, the resistors have values larger than about 40K Ohm for 200 MHz signal transmissions).

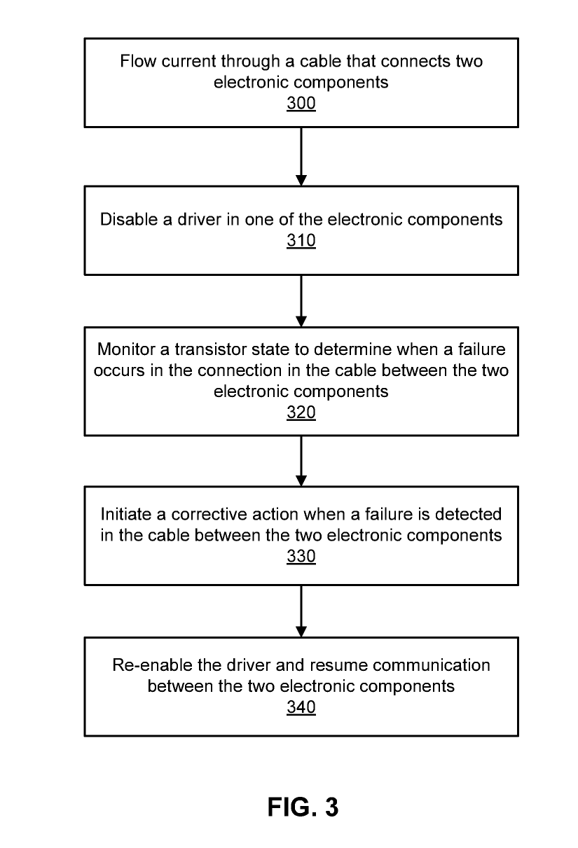

FIG. 3 is a flow diagram of a method that monitors a cable connection in an electronic device in accordance with an example embodiment.

According to block 300, a current flows through a cable that connects two electronic components, such as two printed circuit boards.

According to block 310, a driver is disabled in one of the electronic components. For example looking to FIG. 2, microprocessor 150 disables driver 210.

According to block 320, a transistor state is monitored to determine when a failure occurs in the connection in the cable between the two electronic components. For example looking to FIG. 2, microprocessor 150 monitors the connection in lines 212 and 214 between PCB 120 and PCB 122. When the transistor 230 switches to an on state, the signal to the microprocessor 150 indicates that the connection between the two electronic components is failed or disconnected.

According to block 330, a corrective action is initiated when a failure is detected between the two electronic components. For example looking to FIG. 2, the microprocessor 150 can then take a corrective action, such as providing a notification to a computer or user that the connection between the two electronic components is failed or disconnected.

According to block 340, the driver is re-enabled, and communication between the two electronic components is resumed. For example looking to FIG. 2, the microprocessor 150 re-enables the driver 210, and a normal communication mode is resumed between PCB 120 and PCB 122.

The methods in accordance with example embodiments are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing example embodiments. Such specific information is not provided to limit example embodiments.

What is claimed is:

1) An electronic device, comprising:
a transmitter;
a microprocessor in communication with the transmitter;
a receiver that communicates with the transmitter along a cable using differential signaling; and
a transistor that switches states to communicate a signal to the microprocessor when a wire in the cable is faulty.

2) The electronic device of claim 1 further comprising:
a differential driver that connects between the transmitter and the receiver, wherein one wire of the cable connects to the differential driver and a first resistor, and another wire of the cable connects to the differential driver and a second resistor.

3) The electronic device of claim 1, wherein the cable has two wires, and the transistor connects to one wire of the cable and to the microprocessor.

4) The electronic device of claim 1 further comprising:
a resistor that connects between two wires of the cable, wherein the resistor matches impedances between the two wires and assists in determining when one or more of the two wires is faulty.

5) The electronic device of claim 1, wherein the transistor switches between an on-state and an off-state to communicate the signal to the microprocessor that the wire in the cable is faulty.

6) A cable connection detection system, comprising:
a first circuit board including a transmitter;
a second circuit board including a receiver that communicates with the transmitter with differential signaling through a cable having two wires; and
a transistor connected to the cable, wherein the transistor switches between an on-state and an off-state when a mechanical connection along one of the two wires becomes faulty.

7) The electronic device of claim 6 further comprising:
a differential driver connected to the transmitter;
a microprocessor connected to the transmitter, wherein the microprocessor transmits a driver enable signal to the differential driver, and the transistor transmits to the microprocessor a signal that indicates when the mechanical connection along one of the two wires becomes faulty.

8) The electronic device of claim 6, wherein the receiver and the transmitter communicate with each other using low-voltage differential signaling (LVDS).

9) The electronic device of claim 6, wherein when the mechanical connection along one of the two wires becomes faulty then current stops flowing through the transistor and the transistor switches from an on-state to an off-state.

10) The electronic device of claim 6 further comprising:
a microprocessor that reads a signal from the transistor to determine a failure in one of the two wires.

11) A method, comprising:
flowing current through a cable that has two wires and that connects two electronic components communicating with each other through differential signaling;
disabling a driver in one of the two electronic components; and
monitoring a transistor state to determine when a failure occurs in one of the two wires.

12) The method of claim 11 further comprising:
switching a transistor between an on-state and an off-state when the failure occurs in one of the two wires;
transmitting a signal from the transistor to a microprocessor that indicates when the failure occurs.

13) The method of claim 11 further comprising:
initiating, by a microprocessor located in one of the two electronic components, a corrective action that includes notifying a user when the failure occurs in one of the two wires.

14) The method of claim 11 further comprising:
disabling a driver, located in one of the two electronic components, when the failure occurs in one of the two wires;
re-enabling the driver after a corrective action for the failure occurs.

15) The method of claim 11 further comprising:
communicating data between the two electronic components using low-voltage differential signaling (LVDS) in which data is transmitted over a twisted-pair copper cable that forms part of a network and computer bus.
